(19) United States
(12) Patent Application Publication
(10) Pub. No.: US 2015/0294224 A1
(43) Pub. Date: Oct. 15, 2015

(54) INFORMATION PROCESSING APPARATUS AND CONTROL METHOD THEREOF, AND NON-TRANSITORY COMPUTER-READABLE MEDIUM

(71) Applicant: CANON KABUSHIKI KAISHA, Tokyo (JP)

(72) Inventor: Keita Oshima, Tokyo (JP)

(21) Appl. No.: 14/673,423

(22) Filed: Mar. 30, 2015

(30) Foreign Application Priority Data
Apr. 14, 2014 (JP) 2014-083102

(51) Int. Cl. G06N 5/04; H04L 29/08; H04L 29/06

(52) U.S. Cl. CPC G06N 5/04; H04L 67/42; H04L 67/10

(57) ABSTRACT

An information processing apparatus comprises: a receiving unit that receives a request to store or acquire data from a client; a storing unit that stores the request as history information; a prediction unit that predicts a date/time at which the next request will be received based on the history information; and a notification unit that notifies the client if the next request has not been received by the date/time predicted by the prediction unit.

### BACKGROUND OF THE INVENTION

1. Field of the Invention

The present invention relates to information processing apparatuses and control methods thereof, and to non-transitory computer-readable medium.

2. Description of the Related Art

With services that send and receive data to and from each other, it is necessary for the data to be stored without problems before the data is acquired. Specifically, in the case where data has not been stored due to an unforeseen system problem, it is necessary to respond by storing the data and notifying the service acquiring the data of the problem. As another example, when, in the case where an acquiring service has already acquired data, a storage service stores correction data by overwriting the data, it is necessary to notify the acquiring service that a storage request has been made in order to determine to re-acquire the data or the like.

Thus far, a system that, in the case of direct data cooperation between services, determines or monitors whether there are problems in the cooperation for storing and acquiring the data in accordance with a basis for determination set by the sender and the recipient of the data, has been implemented. For example, there is a technique in which services that cooperate themselves determine the authenticity of stored data by confirming details of that data (see Japanese Patent Laid-Open No. 2005-38155).

In the case of cooperation between two systems, the necessary adjustments between the systems and the necessary means for the systems to be compliant with each other can be provided. However, in the case of system cooperation carried out via a data sharing system, multiple independent systems (systems used by a plurality of sales companies, for example) cooperate with the data sharing system. Different countries have different business practices, and individual companies deal with a variety of circumstances, and thus in this case, it is difficult to implement each system connected to the data sharing system in accordance with the circumstances of the other systems. Accordingly, it is desirable for the systems that connect to the data sharing system to be capable of cooperating through an extremely simplified scheme. Accordingly, there is demand for support for a data storage and acquisition format through which a data sharing system inserted between a plurality of systems facilitates cooperation between the systems.

Meanwhile, the number of cooperating systems varies dynamically or increases, and thus it is not easy to pre-set and manage a schedule of systems to be monitored (and the combinations thereof) in a data sharing system. Although sales company systems experience access that is basically periodic, there are cases where differences in business practices between countries make it impossible to schedule appointments. Furthermore, data sharing systems store various types of data, and thus it is not easy to manage and set the data sharing system to determine the details of data for each instance of system cooperation.

The present invention provides a scheme that automatically determines an error in cooperation, without manually pre-registering cooperation information such as a storage/acquisition schedule and without needing to carry out the determination for each of connected systems.

### SUMMARY OF THE INVENTION

According to one aspect of the present invention, there is provided an information processing apparatus comprising: a receiving unit that receives a request to store or acquire data from a client; a storing unit that stores the request as history information; a prediction unit that predicts a date/time at which the next request will be received based on the history information; and a notification unit that notifies the client if the next request has not been received by the date/time predicted by the prediction unit.

According to another aspect of the present invention, there is provided a control method for an information processing apparatus comprising: receiving a request to store or acquire data from a client; storing the request as history information in a storage unit; predicting a date/time at which the next request will be received based on the history information; and notifying the client if the next request has not been received by the date/time predicted in the predicting.

According to another aspect of the present invention, there is provided a non-transitory computer-readable medium in which is stored a program for causing a computer to function as: a receiving unit that receives a request to store or acquire data from a client; a storing unit that stores the request as history information; a prediction unit that predicts a date/time at which the next request will be received based on the history information; and a notification unit that notifies the client if the next request has not been received by the date/time predicted by the prediction unit.

In data cooperation between systems via a data sharing system, synchronization of data cooperation can be monitored and errors in the synchronization state can be determined and reported.

Further features of the present invention will become apparent from the following description of exemplary embodiments (with reference to the attached drawings).

### BRIEF DESCRIPTION OF THE DRAWINGS

FIG. 1 is a diagram illustrating an example of the hardware configuration of a data sharing system.

FIG. 2 is a diagram illustrating an example of the functional configuration of the data sharing system.

FIG. 3 is a diagram illustrating the timing of a determination of a storage and acquisition combined period.

FIG. 4 is a diagram illustrating the timing of a determination of a storage period.

FIG. 5 is a diagram illustrating the timing of a determination of a second storage period.

FIG. 6 is a diagram illustrating the timing of a determination that target data storage is complete.

FIG. 7 is a diagram illustrating an example of the structure of an access history.

FIGS. 8A and 8B are diagrams illustrating an example of the structure of a monitoring target alert date/time table.

FIG. 9 is a diagram illustrating an example of the configuration of a periodic storage monitoring table.

FIG. 10 is a diagram illustrating an example of an overwrite type data table.

FIG. 11 is a diagram illustrating an example of a history type data table.

FIG. 12 is a flowchart illustrating a request process.

FIG. 13 is a flowchart illustrating an acquisition process.

FIG. 14 is a flowchart illustrating a storage process.

FIGS. 15A and 15B are flowcharts illustrating a process for determining a storage and acquisition combined period.

FIG. 16 is a flowchart illustrating a process for determining a storage period.

FIG. 17 is a flowchart illustrating a monitoring process.

### DESCRIPTION OF THE EMBODIMENTS

Hereinafter, an embodiment of the present invention will be described using the drawings. Note that the configurations described hereinafter are merely examples, and the present invention is not intended to be limited thereto.

Hardware Configuration

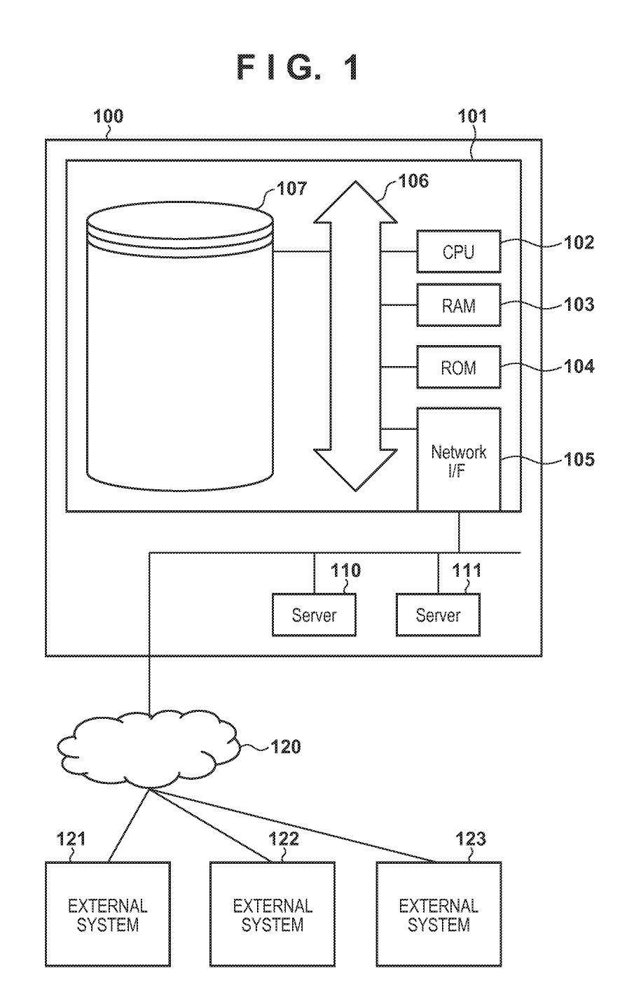

FIG. 1 is a diagram illustrating an example of the hardware configuration of a system according to the present embodiment. A data sharing system 100 is configured of one or more servers connected to each other via a network interface 105. In the present embodiment, servers 101, 110, and 111 are information processing apparatuses that each have the same configuration. The server 101 includes a CPU 102, a RAM 103, a ROM 104, the network interface 105, and an HDD 107, which are connected via a bus 106. Processes performed by the data sharing system 100 are realized by the CPU 102 reading out and executing data and programs recorded in the HDD 107 or the ROM 104 and the RAM 103. There are also cases where such functions are realized by the functions of multiple servers working in cooperation. The network interface 105 is used when functions cooperate between servers in the data sharing system 100, and is also used to communicate with external systems 121, 122, and 123 via an external network 120. It is assumed that the external systems 121-123 are also configured of one or more servers, in the same manner as the data sharing system 100.

In the present embodiment, the respective processing units, processing flowcharts, and so on described below are realized by the CPU 102 of the data sharing system 100 reading out and executing programs stored in a storage unit such as the ROM 104.

Functional Configuration

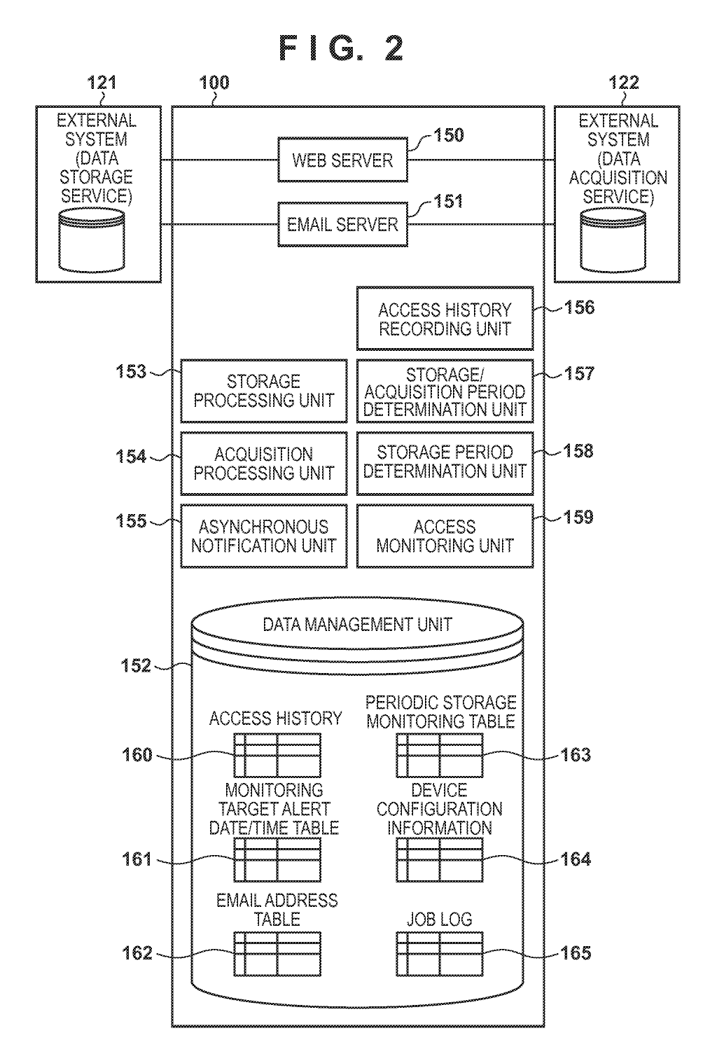

FIG. 2 illustrates an example of the functional configuration of the data sharing system 100 according to the present embodiment. The external system 121 provides a data storage service, which stores data, to the data sharing system 100. The external system 122 provides a data acquisition service, which acquires data, to the data sharing system 100. The data sharing system 100 and the external systems 121 and 122 shown in FIG. 2 correspond to the respective apparatuses illustrated in FIG. 1. Although the example in FIG. 2 illustrates only two external systems, the number of external systems that are connected is not limited thereto. In other words, more external systems can be connected to the data sharing system 100.

The data sharing system 100 operates in cooperation with the external systems 121 and 122. A data management unit 152 manages data such as device configuration information 164 stored and acquired via a Web server 150, a job log 165, a data access history 160, and management tables (161-163) for internal processing. In the present specification, history information such as the access history 160 and the job log 165 will be referred to as “history type” data, whereas setting/management information such as an email address table 162 and the device configuration information 164 will be referred to as “overwrite type” data. The data management unit 152 is in the present embodiment assumed to be a database such as an SQL server or the like, but another filesystem or the like may be used instead.

The Web server 150 is an HTTP server or the like that is compliant with the HTTP (Hypertext Transfer Protocol) specification. The Web server 150 receives and processes HTTP requests from the external systems 121 and 122 that serve as clients, and returns processing results to the clients as responses. In the present embodiment, there are two types of requests, namely a storage request (POST) and an acquisition request (GET), and the details of the requests are processed by a storage processing unit 153 or an acquisition processing unit 154, respectively. The storage processing unit 153 stores, in accordance with a storage request from the external system 121, a resource that is designated in the body of the request in the data management unit 152. Meanwhile, the acquisition processing unit 154 executes, in response to an acquisition request from the external system 122, a search for a resource in the data management unit 152 using a condition designated in the request, and returns search result data.

The “resource” managed by the data management unit 152 indicates a unit of data that is stored/acquired. In the present embodiment, this indicates a combination of a data type and a tenant, which is a unit for which access is controlled. Furthermore, when acquiring a resource, a query character string for acquiring only data that meets a specific condition can be designated as the searched condition. For example, a period of data to be acquired can be designated as a range by designating a date/time. Although the device configuration information 164 and the job log 165 are given as examples of the data type in the present embodiment, other data types can be handled in the same manner. An access history recording unit 156 records requests received by the Web server 150 into the access history 160 within the data management unit 152.

In the case where it can be determined that a combination of a corresponding storage request and acquisition request is present, the data sharing system 100 can predict the timing at which the next request will be made. In the case where that request is not received as expected, the data sharing system 100 determines that an error has occurred in the cooperation, and issues a warning to the external system involved in the cooperation.

The following three patterns can be thought of as specific examples of a case where it is determined that an error has occurred in the cooperation.

(1) In the case where the combination of storage request and acquisition request is received periodically, it is assumed that the requests will arrive periodically in a continuous manner. In this case, an error is determined to have occurred in the case where the periodicity has broken down.

(2) In the case where a storage request for storing data that is a target of the acquisition request is received periodically, it is assumed that the storage request will arrive periodically in a continuous manner. In this case, an error is determined to have occurred in the case where the periodicity has broken down.

(3) The timing at which a corresponding storage request is to be present is specified based on a range of the data that is the target of the acquisition request. An error is determined to have occurred in the case where the storage request is not present at the specified timing.

The access history 160 recorded in the access history recording unit 156 is used in the stated determination as to whether or not an error has occurred. The storage/acquisition period determination unit 157 detects the periodicity of the combination of the storage request and acquisition request from the access history 160, predicts the timing (date/time) at which the next request will arrive, and records that timing in a monitoring target alert date/time table 161. A storage period determination unit 158 detects the periodicity of the storage request from the access history 160, predicts the date/time when the next storage request will arrive, and records that date/time in a periodic storage monitoring table 163. The storage/acquisition period determination unit 157 and the storage period determination unit 158 both detect the periodicity of the storage request, but both of these processing units operate independently from each other.

An access monitoring unit 159 continually monitors whether or not there is a request, asynchronously from the request processing. In the case where the request does not match the predicted date/time recorded in the monitoring target alert date/time table 161 or the periodic storage monitoring table 163, the access monitoring unit 159 passes detected error information to a notification means. The error information notification means includes two means, namely a means for detecting an error when a request has arrived and passing warning information for that error as a response to the request, and a means for notifying when an error has been detected asynchronously from the request. The former is returned as a response of the Web server 150. The latter is carried out by an asynchronous notification unit 155. In the case where an error has been detected by the access monitoring unit 159, the asynchronous notification unit 155 generates a message indicating the details of the error for the external system that is to be notified of the error, and sends that message from an email server 151. The destination of the email is recorded into the monitoring target alert date/time table 161 based on an email address recorded in the email address table 162.

Although sending an email is given as an example of a method for notification using the asynchronous notification unit 155 in the present embodiment, it should be noted that another message sending means may be used as long as the means is capable of sending asynchronously.

Request Timing

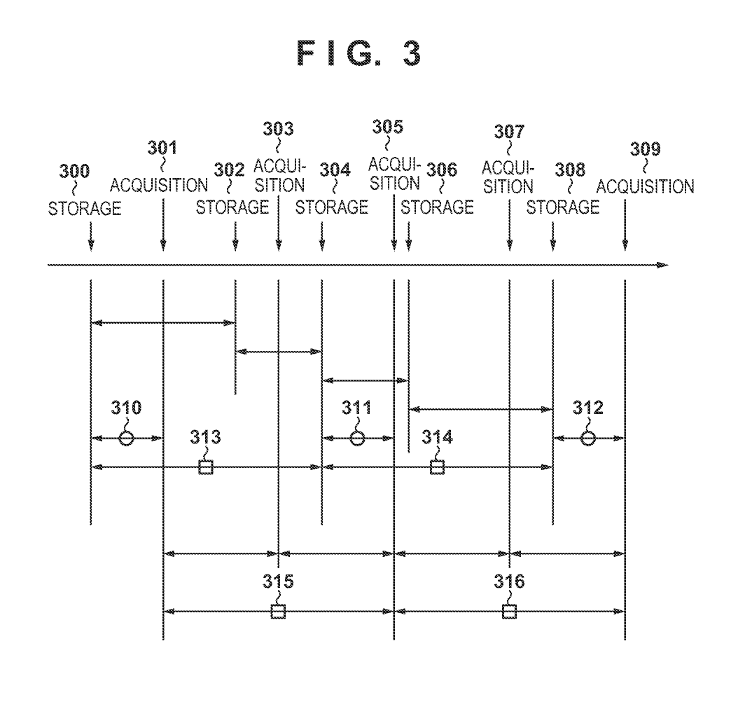

FIG. 3 illustrates an example of access in which there is periodicity in the storage request and acquisition request combination for the same resource, as determined by the storage/acquisition period determination unit 157. Reception timings 300-309 indicate timings at which the storage request and the acquisition request are received. Reception timings 300, 302, 304, 306, and 308 indicate reception timings of storage requests. Meanwhile, reception timings 301, 303, 305, 307, and 309 indicate reception timings of acquisition requests. A time interval 310 indicates a time interval spanning from the reception timing 300 of a storage request to the reception timing 301 of an acquisition request. Likewise, a time interval 311 indicates a time interval spanning from the reception timing 304 to the reception timing 305, and a time interval 312 indicates a time interval spanning from the reception timing 308 to the reception timing 309. Furthermore, a time interval 313 indicates a time interval spanning from the reception timing 300 to the reception timing 304, and a time interval 315 indicates a time interval spanning from the reception timing 301 to the reception timing 305. Likewise, a time interval 314 and a time interval 316 indicate time intervals between the reception timing of a storage request and the reception timing of an acquisition request. FIG. 3 indicates that the time intervals 310, 311, and 312 are equal. FIG. 3 also indicates that the time intervals 313, 314, 315, and 316 are equal. Note that in the present embodiment, in the determination of equal intervals, the processing is carried out allowing for a certain margin of error, rather than intervals that are strictly equal. The margin of error handled here will be described later.

In the case of a reception timing relationship as illustrated in FIG. 3, it can be determined that there is a constant periodicity in the storage request and acquisition request combination with respect to the relationships between requests exhibiting periodic cooperation. Specifically, using the storage request reception timing 308 as a starting point, it can be predicted that a storage request for the same resource will arrive at a timing at which the amount of time indicated by the time interval 314 has passed. Likewise, using the acquisition request reception timing 309 as a starting point, it can be predicted that the timing at which the amount of time indicated by the time interval 316 has passed will be the reception timing of the acquisition request corresponding to the storage request predicted as described above.

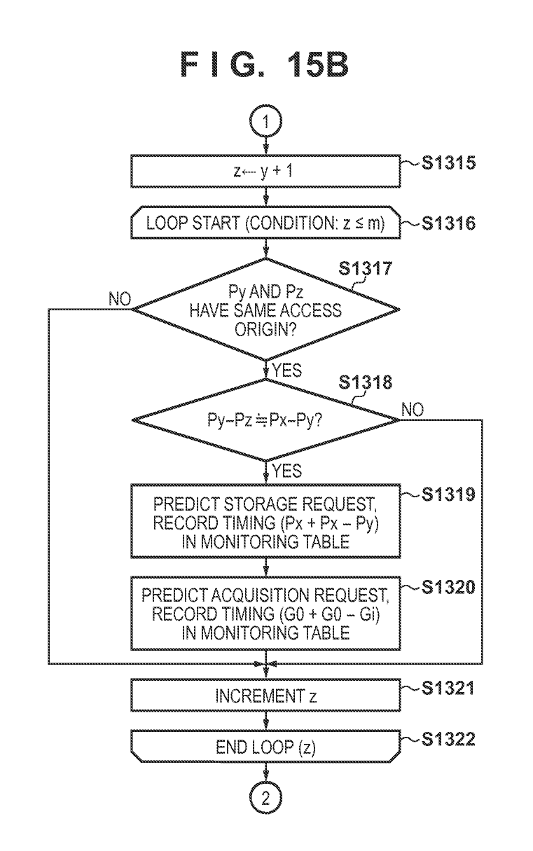

In this manner, in the case where there are three storage requests at equal intervals timewise and three acquisition requests at equal intervals timewise are furthermore present between the respective storage requests, a periodicity can be found in the storage request and acquisition request combination. In FIG. 3, there are other storage requests and acquisition requests, and there are also requests that have equal time intervals therebetween, but the requests that meet the conditions with respect to periodicity correspond to a request group having a relationship indicated by the time interval 310 to the time interval 316. A detailed method for determining periodicity will be described later using FIGS. 15A and 15B.

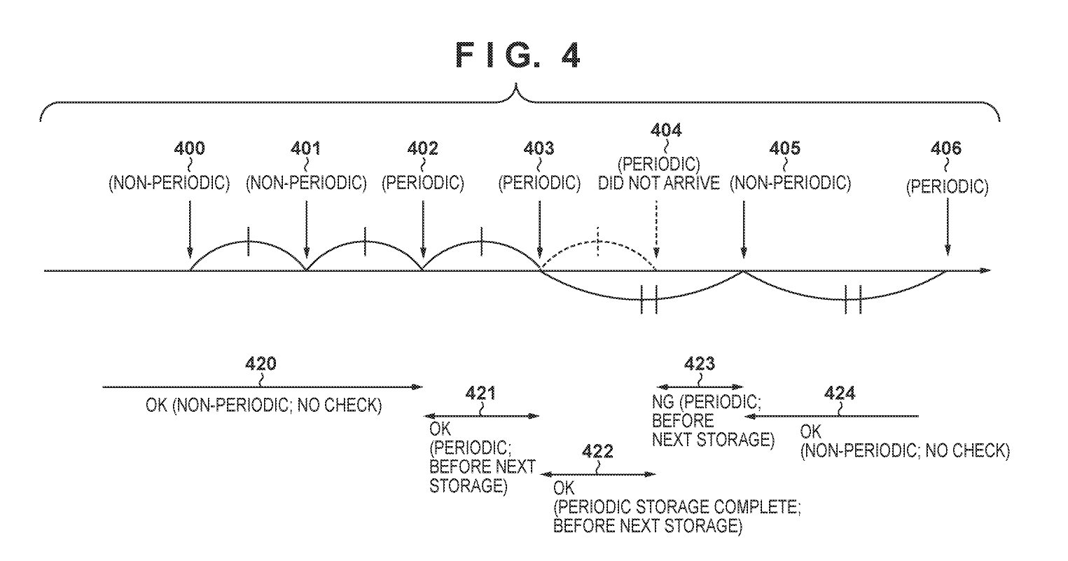

FIG. 4 is a diagram illustrating an example of access timing and periodicity determination for storage requests for the same resource, determined by the storage period determination unit 158. Access date/times 400-406 each indicate an access date/time of a storage request (a tenant ID, an access origin, and a state specified by a resource). Here, the access date/time 404 indicates an expected date/time of access, and indicates that there was no actual access (request) at that access date/time.

At the timings of the access date/time 400 and 401, the storage request was not determined to have periodicity, and thus the storage requests at the access date/time 400 and 401 are determined to be non-periodic requests. When the storage request at the access date/time 402 is received, it is determined that the storage request according to the tenant ID, access origin, and resource is periodic, based on the access date/time of the storage request indicated in the past access date/time 400, 401, and 402. In the case where it has been determined that the storage request at the access date/time 402 is a periodic storage request, it is predicted that the next storage request will come at the timing of the access date/time 403. If the acquisition request arrives by the access date/time 403, which is the predicted timing, it is assumed that the corresponding data is correctly stored, and an acquired data response is correctly returned. Furthermore, if a storage request arrives again at the access date/time 403, which is the predicted timing, the storage request is again determined to be periodic.

On the other hand, in the case where the storage request has not been received at a predicted timing, such as at the access date/time 404, the warning information indicating that the data to be periodically stored is not stored is returned as a response to the acquisition request until the next storage request is received (a period indicated as period 423). In this case, when a storage request is received, that storage request is handled as a non-periodic request. In other words, at that point in time, the warning information response is not returned in response to the acquisition request. The storage request is furthermore received at the timing of the access date/time 406, and it is determined that the storage request is periodic if the intervals between the access date/time 403, 405, and 406 are equal intervals.

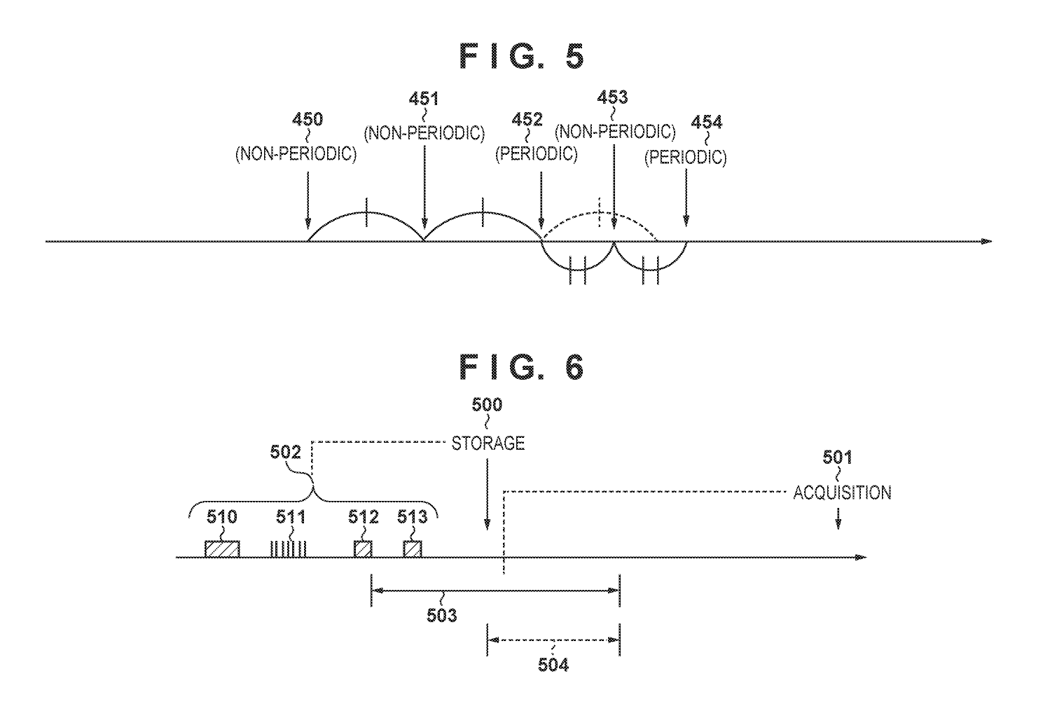

FIG. 5 is a diagram illustrating another periodicity determination for the storage request, determined by the storage period determination unit 158. FIG. 5 indicates that a request is received at reception timings 450, 451, and 452, and that these requests are determined to be periodic storage requests at the point in time corresponding to the reception timing 452. Furthermore, as indicated by reception timing 453, a request is received earlier than the timing at which the next request was predicted to arrive, and thus it is determined that the storage request at the reception timing 453 is a non-periodic request. In this case, the storage request at the reception timing 453 is determined to be a non-periodic storage request at the point in time when that storage request arrives, and thus a warning response is not returned for the acquisition request thereafter. Furthermore, when a storage request is received at reception timing 454 and the time intervals between the reception timings 452, 453, and 454 are equal intervals (almost equal intervals), it is determined that the storage requests at these reception timings are periodic.

FIG. 6 is a timing chart illustrating a relationship between updates to a log, which is history type data, and a range (period) in which data is present during acquisition. In FIG. 6, a timing 500 indicates a timing at which the storage request is received, and a timing 501 indicates a timing at which an acquisition request for a corresponding resource is received. With the storage request received at the timing 500, a log having a timestamp for a range 502 is stored. Meanwhile, an acquisition request received at the timing 501 is assumed to designate a query for acquiring data generated in a range 503.

Meanwhile, in FIG. 6, it is assumed that the final storage request for the target resource is at the timing 500. Here, with the storage request at the timing 500, logs having timestamps distributed as indicated by logs 510-513 are stored, and naturally no logs are recorded at timings that do not exist due to no events occurring. Note that logs for the range 502 being stored at the timing 500 simultaneously indicates that an event that is to be recorded did not occur at the timings in the range 502 where logs are not present. On the other hand, it is not known whether or not an event is present outside of the range that is the subject of the storage request. It may simply be that a log has not yet been recorded, or it may be that an even actually has not occurred. A range 504, within the range 503 in which the acquisition request at the timing 501 is designated, indicates such a range of time. The acquisition processing unit 154 determines such circumstances, and in response to the acquisition request at the timing 501 in FIG. 6, returns the warning information indicating that unspecified or unstored information, as indicated by the range 504, is present.

Data Structure

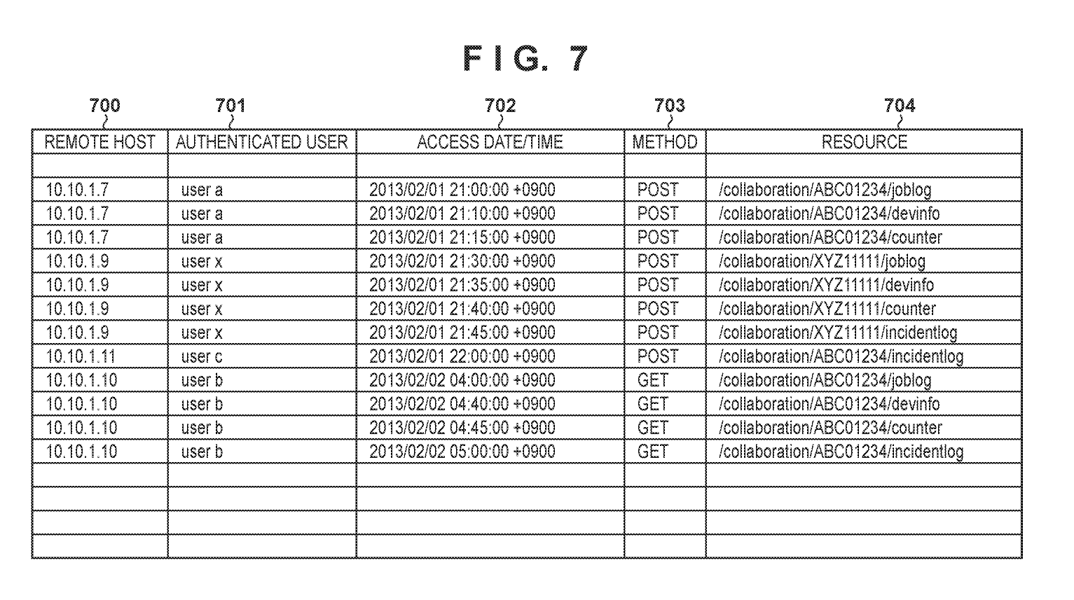

FIG. 7 illustrates an example of the access history 160 according to the present embodiment. Remote host 700 indicates the network address of a remote host that corresponds to the external system that is the access origin. Authenticated user 701 indicates an authenticated user authenticated at the time of access. In the case where a combination of the designated remote host 700 and the authenticated user 701 match at the time of access, the access is considered to come from the same access origin. In the present embodiment, each piece of data is stored in the database in units called tenants, and only a user that has the authority to access the tenant can access the data that belongs to that tenant. In the case where user authentication fails, the failure is generally recorded into the access history, but in the present embodiment, access in the case where authentication has failed is not used in determinations of periodicity for subsequent accesses and the like. Accordingly, in the present embodiment, only an access history in which authentication has succeeded is illustrated, in order to simplify the descriptions.

Access date/time 702 indicates a time stamp showing the access date/time. Method 703 indicates the access method, which is a storage request in the case of POST and an acquisition request in the case of GET. Resource 704 indicates a resource to be accessed. The resource is obtained by extracting the path portion of a resource in a URI (Uniform Resource Identifier), and specifies a data type and tenant ID for access. Note that in the case where a search condition is designated in the acquisition request, the query character string is saved in the column. For the specified resource, POST is processed by the storage processing unit 153, and GET is processed by the acquisition processing unit 154.

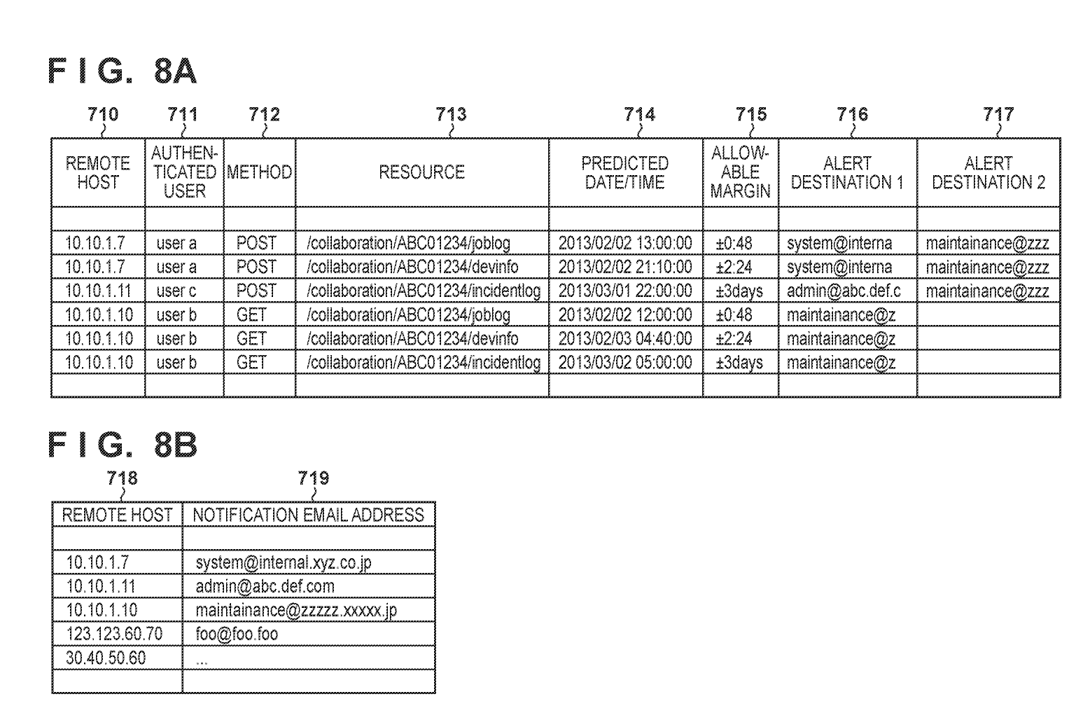

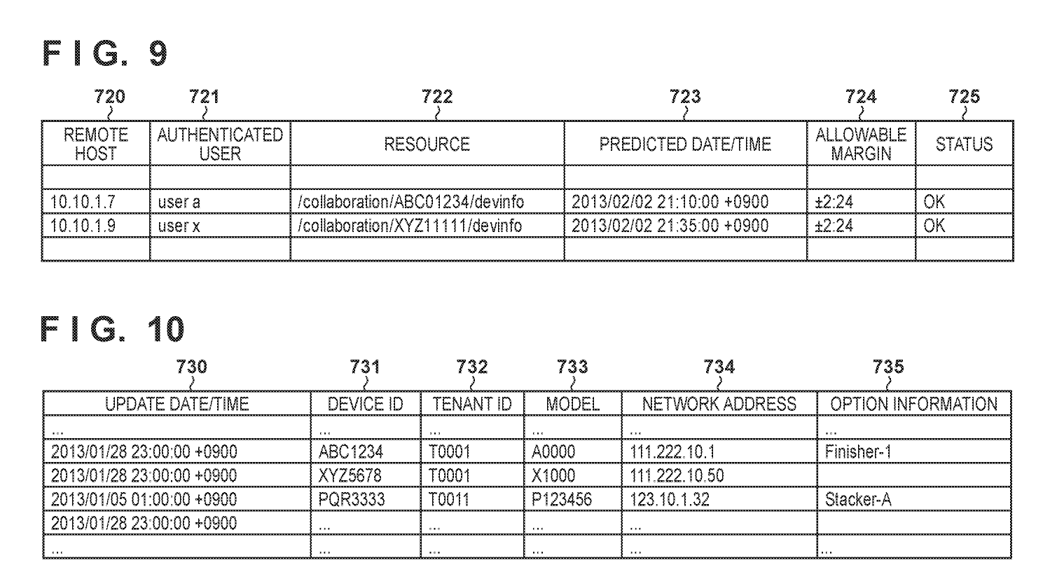

FIGS. 8A and 8B illustrate examples of the structures of tables for recording monitoring targets, regarding the periods of storage request and acquisition request combinations, that are referred to and updated by the access monitoring unit 159.

FIG. 8A illustrates an example of the monitoring target alert date/time table 161. The access monitoring unit 159 monitors the requests by referring to this table, and issues a warning in the case where a request that does not match the periodicity of the storage request and acquisition request has been received, as described with reference to FIG. 3.

Remote host 710 indicates the address of an access origin. Authenticated user 711 indicates the name of an authenticated user executing the access. Method 712 indicates the type of request. Resource 713 indicates the path of the resource subject to the request. Predicted date/time 714 is a date/time at which it is predicted, based on the periodicity determination described with reference to FIG. 3, that the next request will be received. Allowable margin 715 indicates an allowable margin for the predicted date/time. In the case where a request, made by the authenticated user 711, of the method 712 for the resource 713 has not been received from the remote host 710, the access monitoring unit 159 notifies the asynchronous notification unit 155 that the request has not been received at a timing based on the predicted date/time 714 and the allowable margin 715. Through this, the asynchronous notification unit 155 sends the warning information to an email address designated in alert destination 716 and alert destination 717. In the present embodiment, the reason for providing two destinations for warning messages (alert destinations) is because the messages are sent in response to both the corresponding storage request and acquisition request. In the case where the storage request has not been received at the predicted date/time, the asynchronous notification unit 155 sends the warning messages to both the external system that stores the corresponding resource and the external system that acquires the corresponding resource. In the case where the acquisition request has not been received at the predicted date/time, the asynchronous notification unit 155 sends the warning message to the external system to which the acquisition request is to be sent.

FIG. 8B illustrates an example of the email address table 162 indicating the destinations of warning messages corresponding to remote hosts. It is assumed that the email address table 162 is manually registered in advance in the data management unit 152. When registering the monitoring target request indicated in FIG. 8A, the destination for the warning is registered based on the combination of the request type and the remote host by referring to FIG. 8B. Although a request in which the remote host 710 and the authenticated user 711 match is determined to be a target request in FIGS. 8A and 8B, it should be noted that determining a matching request using only the remote host 710 is also useful from the standpoint of making the processing more efficient.

FIG. 9 illustrates an example of the periodic storage monitoring table 163. The periodic storage monitoring table 163 records monitoring targets with respect to the periods of the storage requests. The access monitoring unit 159 monitors the requests by referring to the periodic storage monitoring table 163, and changes statuses in accordance with the periodicity of the storage requests as described with reference to FIG. 4 and FIG. 5. In the case where there is an error in the periodicity of the storage requests, the access monitoring unit 159 returns the warning information as a response to the corresponding acquisition request.

Of the items illustrated in FIG. 9, 720-724 are the same as in the monitoring target alert date/time table 161 illustrated in FIG. 8A. Status 725 indicates the status of a predicted request. As described with reference to FIG. 4 and FIG. 5, in the case where it is determined that a storage request has periodicity, a record is added to the periodic storage monitoring table 163 and the status 725 is set to “OK”. The status of the record in question being “OK” indicates that there is periodicity for the storage request from a request source indicated by remote host 720 and authenticated user 721 to a request destination indicated by resource 722, and that the storage request is being received in accordance with that period.

As indicated by the reception timing 453 in FIG. 5, in the case where the storage request has been received earlier than the period predicted for that storage request, the record is deleted from the periodic storage monitoring table 163 and the storage request is handled as a non-periodic request. In the case where the storage request is not received even when the predicted date/time for the storage request has been reached, “NG” is set in the status 725 for the record in question until the next storage request is received. In the case where the status of the record in question is “NG”, the warning information is returned as the response for the acquisition request that acquires that resource. When a storage request corresponding to that record arrives, the record is deleted from the periodic storage monitoring table 163 and is handled as an non-periodic request. With an acquisition request for a resource corresponding to an non-periodic storage request, the warning information is not returned regardless of whether or not there is a corresponding storage request. This is because the resource in question is originally updated irregularly.

Note that a matching request may be determined using only the remote host 720 in the periodic storage monitoring table 163, in the same manner as with the monitoring target alert date/time table 161 illustrated in FIG. 8A.

FIG. 10 illustrates an example of the device configuration information 164, which of the data types of target resources according to the present embodiment, is overwrite type data. The device configuration information 164 is information for managing registration states of devices to be managed in the data sharing system 100. FIG. 10 illustrates only part of the primary management information in the device configuration information 164.

Update date/time 730 indicates a date/time of registration or updating in the data sharing system 100. Device ID 731 is identification information for uniquely identifying the device managed by that record. Tenant ID 732 indicates identification information of a tenant in which the device is registered, or in other words, a tenant to which the user who uses that device belongs. For example, by selecting a data type of device configuration information as the resource and furthermore designating that tenant ID, only a record having the designated tenant ID as a value becomes a target for storage and acquisition. Model 733 indicates a model name of the device. Network address 734 is a network address on a network to which that device is connected. Option information 735 indicates information of optional units connected to that device.

Overwrite type data such as the device configuration information 164 indicated in FIG. 10 may be updated at any time, and thus it cannot be determined whether or not the current state is the newest state based on the update date/time 730 alone. Accordingly, normally, the data sharing system 100 cannot determine whether the target resource has been appropriately updated in response to an acquisition request. However, in a situation where a storage request that updates the target resource is received periodically, some sort of problem can be thought of as having occurred in the case where that storage request is no longer received. In particular, in the case where a storage request for a resource subject to a corresponding acquisition request has entered such a state, warning that the periodic updates are no longer being carried out as a response to the acquisition request can be employed as a trigger for confirming the reliability of the acquired data.

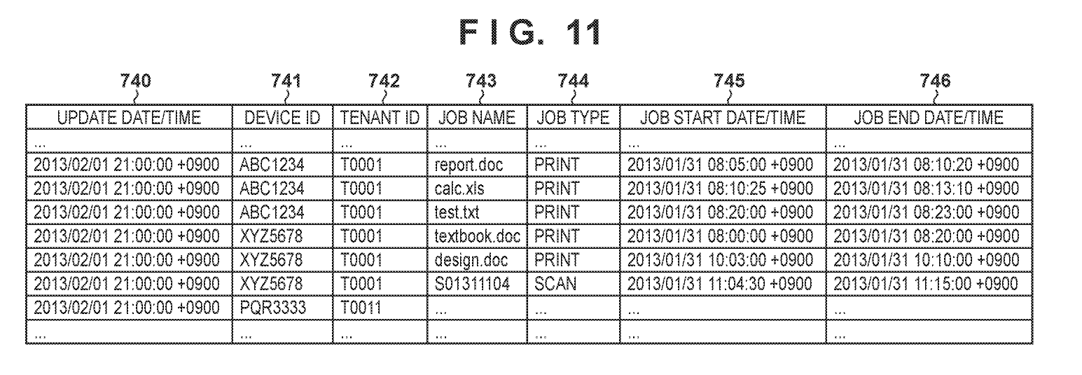

FIG. 11 illustrates an example of the configuration of the job log 165, which of the data types of target resources according to the present embodiment, is history type data. The job log records a log of jobs processed by the devices to be managed in the data sharing system 100. FIG. 11 illustrates only part of the primary information in the job log.

Update date/time 740 indicates a date/time of registration in the data sharing system 100. Device ID 741 is identification information for uniquely identifying the device managed by that record. Tenant ID 742 indicates identification information of a tenant in which the device is registered. Job name 743 indicates the name of the job. Job type 744 indicates the type of the job. Job start date/time 745 and job end date/time 746 indicate a starting date/time and an ending date/time, respectively, of the job.

History type data such as the job log 165 illustrated in FIG. 11 is registered in the data sharing system 100 after information has been produced, and thus information such as the job end date/time 746, for example, is from before the update date/time 740. In the case where an external system has sent an acquisition request with a query condition such as that the job end date/time is in a period within a predetermined range, it is necessary for the storage request corresponding to the resource designated therein to at least be after the range of the designation query. Accordingly, in the case of a state such as that shown in FIG. 6, issuing a warning that the necessary information may not yet be stored in response to the acquisition request can be used as a trigger for a user or the like to confirm the reliability of the acquired data.

Processing Flow

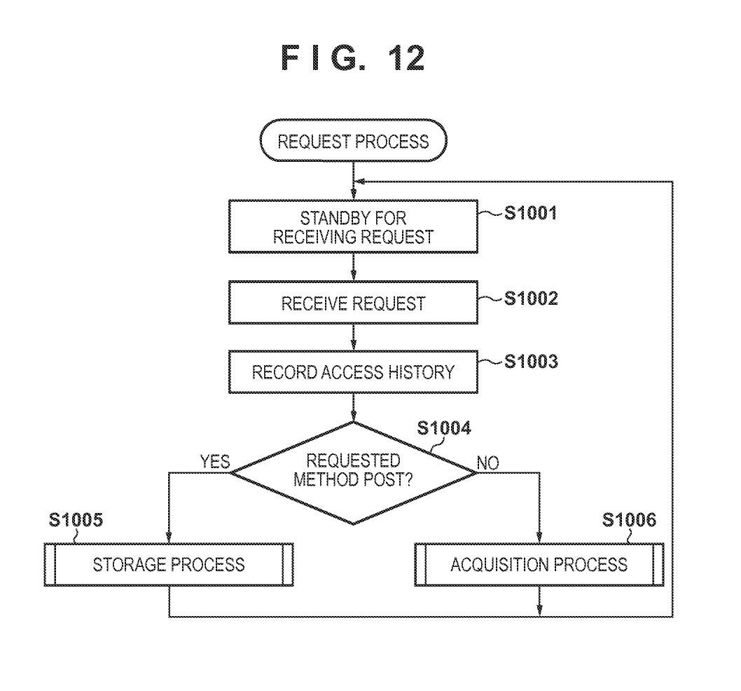

FIG. 12 is a flowchart illustrating the flow of a request process in the data sharing system 100. In the present embodiment, this processing flow is realized by the CPU 102 reading out and executing programs stored in the ROM 104 or the like. The following processing is repeated when the data sharing system 100 starts the processing.

In S1001, the Web server 150 stands by for a request from an external system. In S1002, the Web server 150 receives the request. In S1003, the access history recording unit 156 records the access history. In S1004, the Web server 150 determines the type of the request.

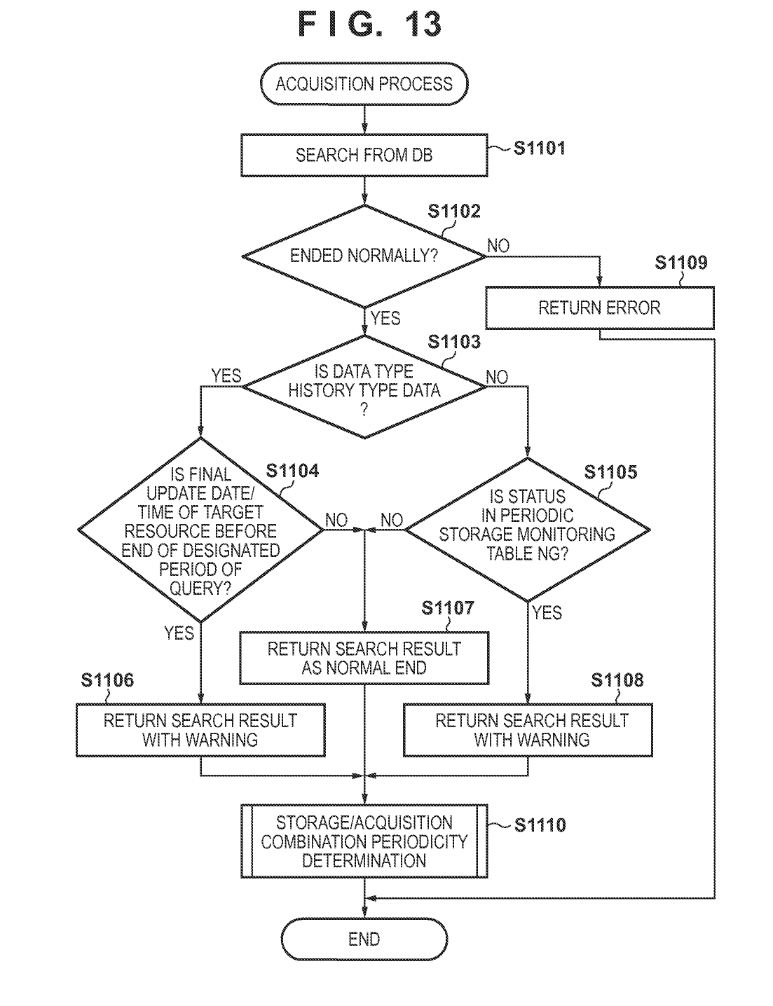

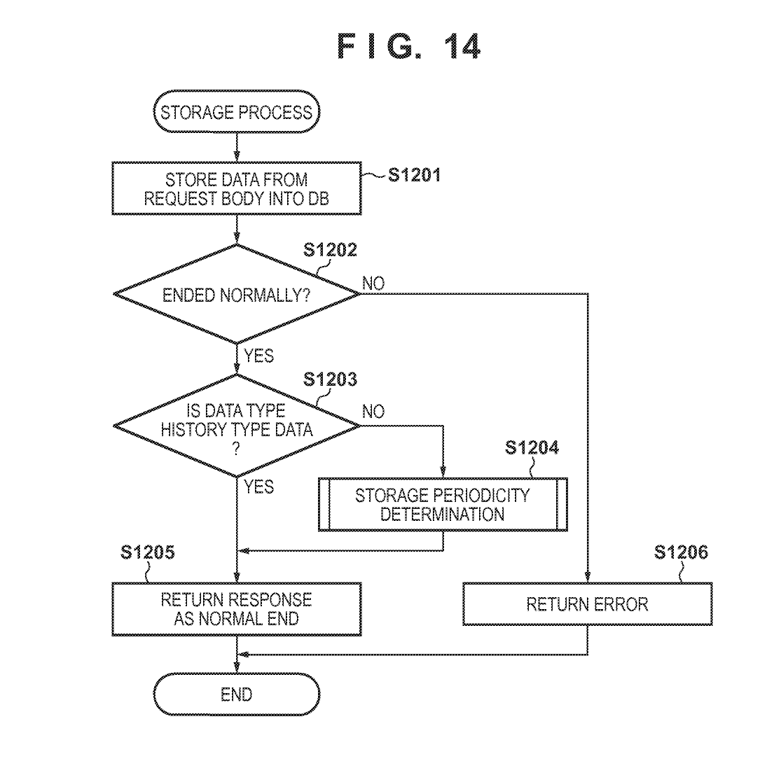

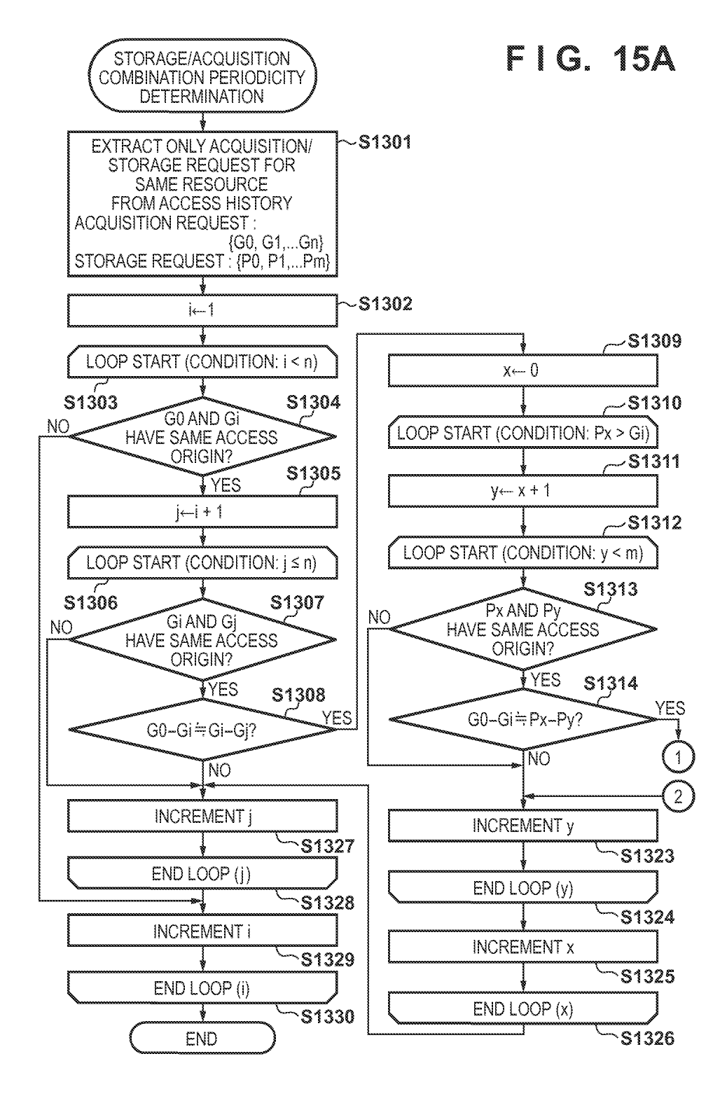

In the case where the requested HTTP method is POST (YES in S1004), in S1005, the storage processing unit 153 carries out a storage process. The processing performed in this step will be described later using FIG. 14. In the case where the requested HTTP method is GET (NO in S1004), in S1006, the acquisition processing unit 154 carries out an acquisition process. The processing performed in this step will be described later using FIG. 13. In the case where the Web server 150 is compliant with another HTTP method, the processing performed by the Web server 150 also branches to other processing, but descriptions thereof will be omitted in the present embodiment. Although this flowchart illustrates the processing as being repeated, multiple processing threads may be created in the request reception (S1002) and multiple requests may be processed in parallel.

Acquisition Process

FIG. 13 is a flowchart illustrating the process of S1006 in FIG. 12, performed by the acquisition processing unit 154, in detail.

In S1101, the acquisition processing unit 154 searches the data management unit 152 for data to return, using a search condition designated in the acquisition request. When the search process ends, in S1102, the acquisition processing unit 154 determines a result of the process. In the case where the process has not ended normally (NO in S1102), in S1109, the acquisition processing unit 154 returns an error to the request source. The processing flow then ends and returns to the processing illustrated in FIG. 12.

In the case where the process has ended normally (YES in S1102), in S1103, the acquisition processing unit 154 determines the data type of the resource. In the case where the data type is history type data (YES in S1103), in S1104, the acquisition processing unit 154 determines whether or not a period in which it is possible that nothing is stored is present in the period designated for acquisition, as described with reference to FIGS. 6 and 11. In the case where the final update date/time of the resource in question is before the designated period for acquisition (YES in S1104), in S1106, the acquisition processing unit 154 adds the warning information and returns the search result to the request source. The process then moves to S1110. In the case where the final update date/time is after the designated period (NO in S1104), in S1107, the acquisition processing unit 154 ends the process normally and returns the search result to the request source. The process then moves to S1110.

On the other hand, in the case where the data type is overwrite type data (NO in S1103), in S1105, the acquisition processing unit 154 determines whether or not there is an error in the periodicity of the storage request for the target data, as described with reference to FIGS. 4, 5, and 10. In the case where the status 725 of the resource being searched for in the periodic storage monitoring table 163 is “NG” (YES in S1105), in S1108, the acquisition processing unit 154 adds the warning information and returns the search result to the request source. The process then moves to S1110. In the case where the status is not “NG”, in S1107, the acquisition processing unit 154 ends the process normally and returns the search result to the request source. The process then moves to S1110.

In S1110, the acquisition processing unit 154 determines the periodicity of the storage request and acquisition request combination, as described with reference to FIG. 3. This process will be described in detail using FIGS. 15A and 15B.

Storage Process

FIG. 14 is a flowchart illustrating the process of S1005 in FIG. 12, performed by the storage processing unit 153, in detail.

In S1201, the storage processing unit 153 stores the data designated by the storage request in the data management unit 152. When the storage process ends, in S1202, the storage processing unit 153 determines a result of the process. In the case where the process has not ended normally (NO in S1202), in S1206, the storage processing unit 153 returns an error to the request source. The processing flow then ends and returns to the processing illustrated in FIG. 12.

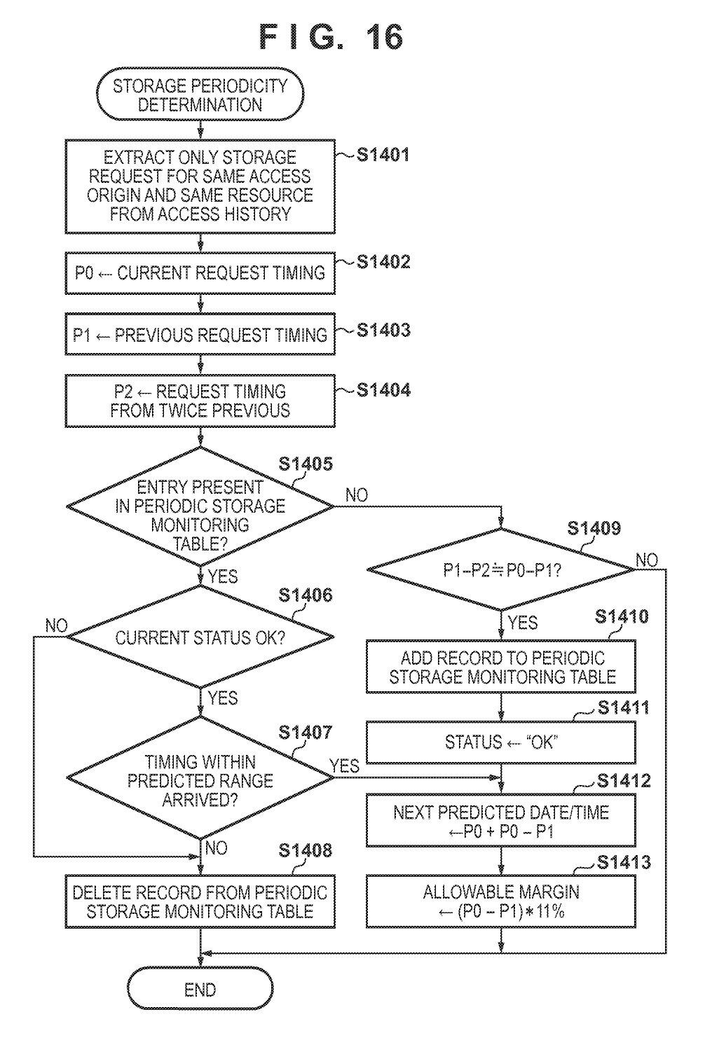

On the other hand, in the case where the process has ended normally (YES in S1202), in S1203, the storage processing unit 153 determines the data type of the resource. In the case where the data is overwrite type data (NO in S1203), in S1204, the storage processing unit 153 carries out a periodicity determination process for the storage request. This process will be described in detail using FIG. 16. The process then moves to S1205.

In the case where the data type is history type data (YES in S1203), in S1205, the storage processing unit 153 returns a status indicating the process has ended normally to the request source. The processing flow then ends and returns to the processing illustrated in FIG. 12.

Storage/Acquisition Combination Periodicity Determination Process

FIGS. 15A and 15B are flowcharts illustrating the process of S1110 in FIG. 13, performed by the storage/acquisition period determination unit 157, in detail.

In S1301, the storage/acquisition period determination unit 157 extracts only the acquisition request and the storage request for the same resource from the access history. Hereinafter, the timing (date/time) of each extracted acquisition request is indicated by G0, G1, and so on up to Gn in order from the newest, moving backward from the point in time of the processing of FIG. 13. Here, Gn corresponds to the final acquisition request in the access history 160. G0, meanwhile, corresponds to the acquisition request processed in the flowchart of FIG. 13. Meanwhile, the timing (date/time) of each extracted storage request is indicated by P0, P1, and so on up to Pm in order from the newest, moving backward from the point in time of the processing of FIG. 13. Here, Pm corresponds to the final storage request in the access history 160.

The flowcharts of FIGS. 15A and 15B will be described using variables i, j, x, y, and z for indicating repetitions. FIGS. 15A and 15B illustrate processing for searching for a total of six requests in which the intervals of three acquisition requests including G0 and the intervals of three storage requests in which the final storage request arrives between the last two of the aforementioned three acquisition requests are all equal intervals. Although the present embodiment describes three each of the acquisition request and the storage request, it should be noted that the processing may be carried out for a greater number of requests.

S1303-S1330 indicate a loop for determining an acquisition request Gi that is one previous from G0. Because it is necessary to acquire three acquisition requests, i does not include n in the determination condition of S1303. S1303 and S1330 define a processing loop carried out from S1304 to S1328 while incrementing i (S1329) during a period where i is less than n.

In S1304, the storage/acquisition period determination unit 157 determines whether or not G0 and Gi are requests from the same access origin. In the case where the access origins are the same (YES in S1304), the process moves to S1305 in order to further examine the request corresponding to Gj. In the case where the access origins are not the same (NO in S1304), the process moves to S1329 to examine the next Gi.

In S1305, the storage/acquisition period determination unit 157 takes j as the next value after i in order to examine the requests in order from the next request after Gi. S1306-S1328 indicate a loop for determining an acquisition request Gj that is two previous from G0. S1306 and S1328 define a processing loop carried out from S1307 to S1326 while incrementing j (S1327) during a period where j is no greater than n.

In S1307, the storage/acquisition period determination unit 157 determines whether Gi and Gj are requests from the same access origin. In the case where the access origins are the same (YES in S1307), the process moves to S1308. In the case where the access origins are not the same (NO in S1307), the process moves to S1327.

In S1308, the storage/acquisition period determination unit 157 determines whether the three acquisition requests (G0, Gi, Gj) provisionally determined at this time have equal intervals, allowing for a predetermined margin. In the present embodiment, the predetermined margin used here is assumed to be 11% or less of the difference between request intervals. Note that 11% allows for an interval difference at which the margin becomes highest, including leap year, when considering periodic processing on a monthly basis. Here, equal intervals (or almost equal intervals) are indicated by “≈”.

In the case where the intervals are determined to be equal intervals (YES in S1308), in S1309, the storage/acquisition period determination unit 157 furthermore searches for storage requests having equal intervals, including the storage request. In the case where it is determined that the intervals are not equal intervals (NO in S1308), the process moves to S1307, where the process for searching for the next acquisition request is continued.

In S1309, the storage/acquisition period determination unit 157 sets x to an initial value of 0 in order to examine the storage requests from the beginning. S1310-S1326 indicates a loop for determining a newest storage request Px among the storage requests having equal intervals. Here, the condition for Px in S1310 is that Px is a request that is after Gi (the timing of the central acquisition request provisionally determined at this point in time). This is because if storage requests at equal intervals have been found in requests prior to Gi, the timing of the next predicted storage request will be further in the past than the current point in time, and the periodicity has already broken down. S1310 and S1326 indicate a loop from S1311 to S1324 in which x is incremented (S1325) during a period in which Px is a request that comes after Gi.

In S1311, the storage/acquisition period determination unit 157 takes y as the next value after x in order to examine the requests in order from the next request after Px.

S1312-S1324 indicate a loop for determining a storage request Py that is one previous from Px. Because it is necessary to acquire three storage requests, y does not include m (S1312). S1312 and S1324 define a processing loop carried out from S1313 to S1322 while incrementing y (S1323) during a period where y is less than m.

In S1313, the storage/acquisition period determination unit 157 determines whether or not Px and Py are requests from the same access origin. In the case where the access origins are the same (YES in S1313), the process moves to S1314. In the case where the access origins are not the same (NO in S1313), the process moves to S1323.

In S1314, the storage/acquisition period determination unit 157 determines whether the three acquisition requests and two storage requests (Px and Py) provisionally determined at this point in time have equal intervals, allowing for a predetermined margin in the same manner as above. In the case where the intervals are determined to be equal intervals (YES in S1314), the process moves to S1315. In the case where it is determined that the intervals are not equal intervals (NO in S1314), the storage/acquisition period determination unit 157 continues the process for searching for the next storage request.

In S1315, the storage/acquisition period determination unit 157 takes z as the next value after y in order to examine the requests in order from the next request after Py.

S1316-S1322 indicate a loop for determining the third storage request. S1316 and S1322 define a processing loop carried out from S1317 to S1320 while incrementing z (S1321) during a period where z is no greater than m.

In S1317, the storage/acquisition period determination unit 157 determines whether Py and Pz are requests from the same access origin. In the case where the access origins are the same (YES in S1317), the process moves to S1318. In the case where the access origins are not the same (NO in S1317), the process moves to S1321.

In S1318, the storage/acquisition period determination unit 157 determines whether or not the three acquisition requests and the three storage requests are at equal intervals as described above. In the case where the intervals are determined to be equal intervals (YES in S1318), in S1319, the storage/acquisition period determination unit 157 predicts date/time of the next storage request. The storage/acquisition period determination unit 157 predicts that the next storage request will be received at the same interval as the request interval of Px and Py, and adds a record to the monitoring target alert date/time table 161 illustrated as an example in FIGS. 8A and 8B. With respect to the allowable margin 715, it is assumed that a span of 11% has been added to the request interval between Px and Py.

In S1320, the storage/acquisition period determination unit 157 predicts the date/time of the next acquisition request. The storage/acquisition period determination unit 157 predicts that the next acquisition request will be received at the same interval as the request interval of Px and Py, and adds a record to the monitoring target alert date/time table 161 illustrated as an example in FIGS. 8A and 8B. With respect to the allowable margin 715, it is assumed that a span of 11% has been added to the request interval between Px and Py.

In the case where it is determined that the intervals are not equal intervals (NO in S1318), the storage/acquisition period determination unit 157 continues the process for searching for the next storage request.

Storage Periodicity Determination Process

FIG. 16 is a flowchart illustrating the process of S1204 in FIG. 14, performed by the storage period determination unit 158, in detail.

In S1401, the storage period determination unit 158 extracts, from the access history 160, the storage request for the same access origin and the same resource as in the storage request processing in FIG. 14. In S1402, the storage period determination unit 158 takes P0 as the timing of the current storage request processed as illustrated in FIG. 14. In S1403, the storage period determination unit 158 takes P1 as the timing of the previous storage request. In S1404, the storage period determination unit 158 takes P2 as the timing of the storage request twice previous.

In S1405, the storage period determination unit 158 confirms whether there is a record, in the periodic storage monitoring table 163 illustrated in FIG. 9, having the same access origin and the same resource. In the case where such a record is present (YES in S1405), the process moves to S1406. In the case where such a record is not present (NO in S1405), the process moves to S1409.

In S1406, the storage period determination unit 158 determines whether or not the status 725 of the existing record has periodicity (“OK”). In the case where there is periodicity (YES in S1406), the process moves to S1407. In the case where the status 725 is “NG” (NO in S1406), in S1408, the storage period determination unit 158 deletes the corresponding record from the periodic storage monitoring table 163. The processing flow then ends and returns to the processing illustrated in FIG. 14.

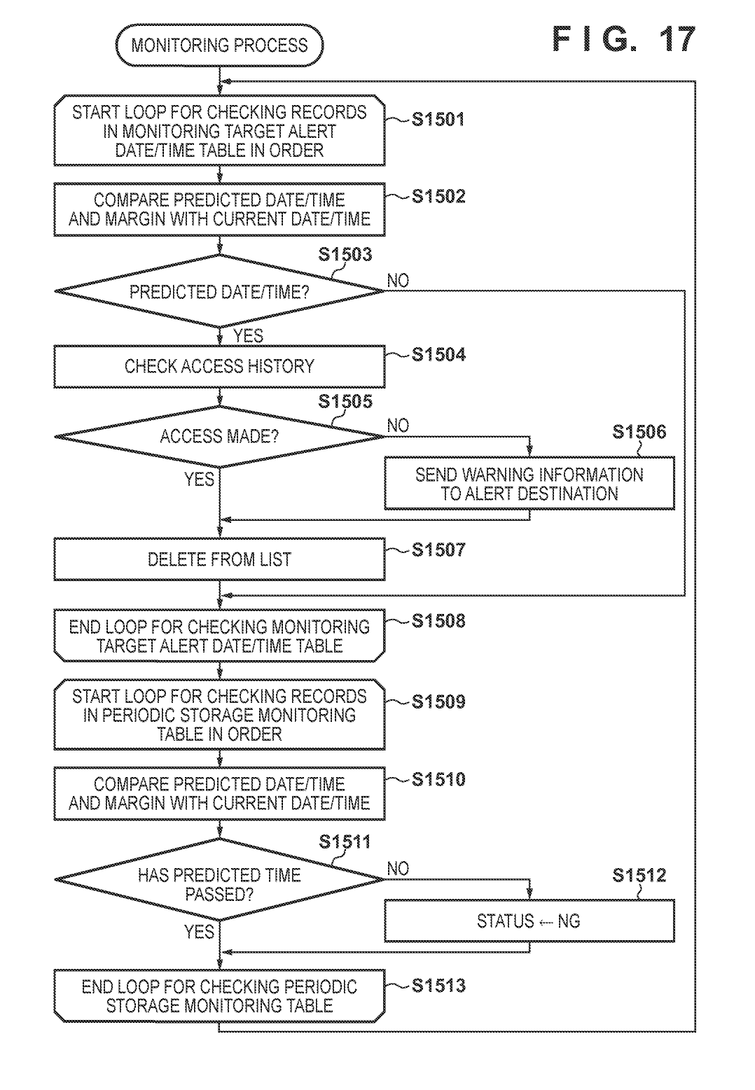

In S1407, the storage period determination unit 158 determines whether or not the current storage request was received at a timing within the predicted range recorded in the periodic storage monitoring table 163. In the case where the predicted timing is not within the range (NO in S1407), the storage period determination unit 158 determines that the request was received earlier than the predicted timing, and in S1408, the storage period determination unit 158 deletes the corresponding record from the periodic storage monitoring table 163. Note that in the case where a request has not arrived even when the predicted timing has been reached, the storage period determination unit 158 changes the status 725 to “NG” in the monitoring process illustrated in FIG. 17. In the case where a request has been received within the range of the predicted timing (YES in S1407), the process moves to S1412.

In S1409, the storage period determination unit 158 determines whether the three acquisition requests (P0, P1, P2) are at equal intervals, allowing for a predetermined margin. As described above, the predetermined margin in the present embodiment is a difference within 11% from the request intervals. In the case where the intervals are equal intervals (YES in S1409), the process moves to S1410. However, in the case where the intervals are not equal intervals (NO in S1409), the processing flow ends and returns to the processing illustrated in FIG. 14.

In S1410, the storage period determination unit 158 adds the corresponding record to the periodic storage monitoring table 163. In S1411, the storage period determination unit 158 sets the status 725 in that record to “OK”. In S1412, the storage period determination unit 158 sets the next predicted date/time 723 by predicting that the next storage request will be received at the same interval as the request intervals for P0 and P1. In S1413, the storage period determination unit 158 sets the allowable margin 724 to a margin in which a range of 11% has been added to the request interval between Px and Py. The processing flow then ends and returns to the processing illustrated in FIG. 14.

Monitoring Process

FIG. 17 is a flowchart illustrating the flow of a process performed by the access monitoring unit 159. When the data sharing system 100 commences operations, the processing illustrated in FIG. 17 operates in parallel with the request process illustrated in FIG. 12.

In S1501 to S1508, the access monitoring unit 159 scans the monitoring target alert date/time table 161 illustrated in FIGS. 8A and 8B in order and confirms whether or not the current date/time has reached the predicted date/time of the request that has been recorded.

In S1502, the access monitoring unit 159 compares the predicted date/time 714 with the current time. In S1503, the access monitoring unit 159 determines whether or not the predicted date/time has been reached as a result of the comparison carried out in S1502. In the case where the predicted time has not been reached (NO in S1503), the access monitoring unit 159 proceeds to confirm the next record. In the case where the predicted date/time has been reached (YES in S1503), in S1504, the access monitoring unit 159 confirms the access history 160 illustrated in FIG. 7.

In the case where the access monitoring unit 159 has confirmed, as a result of S1504, that there is access within the predicted range including the allowable margin (YES in S1505), in S1507, the access monitoring unit 159 deletes the corresponding record from the monitoring target alert date/time table 161.

In the case where the confirmation indicates that there is no access (NO in S1505), in S1506, the access monitoring unit 159 sends a warning message indicating that the request was not received as expected to the email addresses in the alert destinations 716 and 717 in the monitoring target alert date/time table. The process then moves to S1507.

In S1509 to S1513, the access monitoring unit 159 scans the periodic storage monitoring table 163 illustrated in FIG. 9 in order, and determines whether or not the current date/time has reached the predicted date/time for a request that has been recorded. In S1510, the access monitoring unit 159 compares the predicted date/time 723 with the current date/time. In S1511, the access monitoring unit 159 determines whether or not the predicted date/time has been passed, in consideration of the allowable margin 724, as a result of the comparison carried out in S1510. In the case where the predicted date/time has been passed (YES in S1511), in S1512, the access monitoring unit 159 sets the status 725 of the corresponding record to “NG”.

Through this, the data sharing system can determine the presence of a storage request and an acquisition request for cooperation based on the access history, and can issue a warning of an error in the cooperation state to the source of the request based on whether or not there is a corresponding request. As a result, in the case where a combination of external systems that are to cooperate is present, a state of cooperation involved in the data sharing can be monitored without providing each external system with a special means. Furthermore, it is not necessary to make individual settings manually with respect to monitoring schedules.

Because the notification means can be implemented as two means, namely an asynchronous warning notification through email and returning the warning information as a response through an access IF, either or both of these means can be selected in accordance with the type, circumstances, and so on of the external systems. Although the present embodiment describes sending an email as an example of an asynchronous notification means, another event notification means may be used instead.

Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-083102, filed Apr. 14, 2014, which is hereby incorporated by reference herein in its entirety.

What is claimed is:

1. An information processing apparatus comprising:
a receiving unit that receives a request to store or acquire data from a client;
a storing unit that stores the request as history information;
a prediction unit that predicts a date/time at which the next request will be received based on the history information; and
a notification unit that notifies the client if the next request has not been received by the date/time predicted by the prediction unit.

2. The information processing apparatus according to claim 1,
wherein the prediction unit determines a periodicity of the request received by the receiving unit based on the history information and predicts the date/time at which the next request will be received.

3. The information processing apparatus according to claim 2,
wherein the prediction unit specifies, from among the requests received by the receiving unit, a plurality of storage requests received periodically at equal intervals and a plurality of acquisition requests received periodically at equal intervals in correspondence with the plurality of storage requests.

4. The information processing apparatus according to claim 2,
wherein when determining the periodicity of a request received by the receiving unit based on the history information, the prediction unit sets a predetermined margin range for a time interval between received requests.

5. The information processing apparatus according to claim 2,
wherein the prediction unit determines the periodicity of the request based on a source of the request and a type of target data.

6. The information processing apparatus according to claim 2,
wherein if the next request has not been received by the predicted date/time, the prediction unit determines a new periodicity based on the history information when the next request is received.

7. The information processing apparatus according to claim 1,
wherein the prediction unit sets a predetermined margin range for a date/time at which the next request will be received.

8. The information processing apparatus according to claim 1,
wherein if data designated when an acquisition request has been received is not stored due to a storage request for that data not having been received, the notification unit makes a notification that the data is not stored.

9. A control method for an information processing apparatus comprising:
receiving a request to store or acquire data from a client;
storing the request as history information in a storage unit;
predicting a date/time at which the next request will be received based on the history information; and
notifying the client if the next request has not been received by the date/time predicted in the predicting.

10. The control method for an information processing apparatus according to claim 9,
wherein the predicting determines a periodicity of the requests received in the receiving based on the history information and predicts the date/time at which the next request will be received.

11. The control method for an information processing apparatus according to claim 10,
wherein the predicting specifies, from among the requests received in the receiving, a plurality of storage requests received periodically at equal intervals and a plurality of acquisition requests received periodically at equal intervals in correspondence with the plurality of storage requests.

12. The control method for an information processing apparatus according to claim 10,
wherein when determining the periodicity of a request received in the receiving based on the history information, the predicting sets a predetermined margin range for a time interval between received requests.

13. The control method for an information processing apparatus according to claim 10,
wherein the predicting determines the periodicity of the request based on a source of the request and a type of target data.

14. The control method for an information processing apparatus according to claim 10,
wherein if the next request has not been received by the predicted date/time, the predicting determines a new periodicity based on the history information when the next request is received.

15. The control method for an information processing apparatus according to claim 9,
wherein the predicting sets a predetermined margin range for a date/time at which the next request will be received.

16. The control method for an information processing apparatus according to claim 9,
wherein if data designated when an acquisition request has been received is not stored due to a storage request for that data not having been received, the notifying makes a notification that the data is not stored.

17. A non-transitory computer-readable medium in which is stored a program for causing a computer to function as:
a receiving unit that receives a request to store or acquire data from a client;
a storing unit that stores the request as history information;
a prediction unit that predicts a date/time at which the next request will be received based on the history information; and
a notification unit that notifies the client if the next request has not been received by the date/time predicted by the prediction unit.
